(19) United States
(12) Patent Application Publication
(10) Pub. No.: US 2019/0066205 A1
(43) Pub. Date: Feb. 28, 2019

(54) PEER-TO-PEER TRADING WITH BLOCKCHAIN TECHNOLOGY

(71) Applicant: StartEngine Crowdfunding, Inc., Santa Monica, CA (US)

(72) Inventor: Howard Marks, Los Angeles, CA (US)

(21) Appl. No.: 15/819,111

(22) Filed: Nov. 21, 2017

Related U.S. Application Data
(60) Provisional application No. 62/552,057, filed on Aug. 30, 2017.

(51) Int. Cl. G06Q 40/04; G06Q 40/06; G06Q 20/40; H04L 29/08; G06F 9/54

(52) U.S. Cl. CPC G06Q 40/04; G06Q 40/06; G06Q 20/401; H04L 9/0637; H04L 67/104; G06F 9/547; G06Q 20/405

(57) ABSTRACT

Introduced here are computer programs and associated computer-implemented techniques for facilitating complex transactions involving securities through the use of blockchain technology. A network-accessible management platform (also referred to as an “alternative trading system” or “ATS”) may be responsible for using a blockchain to efficiently and securely manage trades of securities. The network-accessible management platform can be communicatively coupled to a transfer agent module responsible managing the ownership of securities purchased by investors and/or a trading module responsible for receiving input indicative of requested purchases/sales of securities. The network-accessible management platform can facilitate transfers of securities from one investor to another investor without the fear of data loss or the high costs that are ordinarily imposed on securities transfers.

### CROSS-REFERENCE TO RELATED APPLICATIONS

This application claims priority to U.S. Provisional Patent Application No. 62/552,057 titled “PEER TO PEER TRADING WITH THE BLOCKCHAIN” and filed on Aug. 30, 2017, which is incorporated by reference herein in its entirety.

### TECHNICAL FIELD

Various embodiments concern computer programs and associated computer-implemented techniques for facilitating complex transactions involving securities through the use of blockchain technology.

### BACKGROUND

Since the creation of the Securities and Exchange Commission (SEC) and the enactment of the Securities Act of 1933, companies have needed to register their offerings and securities with the SEC if the companies wanted to sell securities to the general public. Only accredited investors (i.e., those investors with an income exceeding $200,000 and a net worth of at least $1 million, excluding the value of the primary residence) were allowed to make investments in private companies. Typically, these investments in private companies have provided higher returns to investors when compared to purchasing securities of public companies on the stock exchanges.

These requirements changed on Apr. 5, 2012, when the Jumpstart Our Business Startups (JOBS) Act was signed into law by President Barack Obama. The JOBS Act is a bipartisan law intended to help small companies raise capital and hire the individuals needed to grow/build a successful business. The JOBS Act changed the conventional requirements by permitting companies to sell securities directly to the general public if the companies first registered their offerings with the SEC. Several regulations have emerged from the JOBS Act that are being used by companies to raise capital:
Regulation Crowdfunding, which permits companies to raise up to $1 million in capital per year from the general public after filing a Form C with the SEC's EDGAR public database.
Regulation A+, which permits companies to raise up to $50 million in capital per year from the general public after filing a Form 1A with the SEC for review/comments. However, in order to pursue Regulation A+, a company must be qualified by the SEC. The qualification process can be costly and time consuming (e.g., the qualification process may take several months).
Rule 506(c) of Regulation D, which permits companies to raise capital directly from accredited investors with no limit. Rule 506(c) requires that a company file a Form D with the SEC following the close of fundraising. While the process is inexpensive, fundraising is limited to accredited investors and the securities can only be traded between accredited investors.

Small companies with less than 50 employees form the backbone of the United States economy by generating more jobs than medium companies and large companies. There are more than five million businesses operating in the United States, and many of them seek capital for acquiring equipment, purchasing inventory, improving property, leasing space, hiring employees, etc.

However, because many of these businesses are small companies, accessing capital can be very hard. Banks typically will not lend to small companies if they do not have tangible assets or a sufficient track record of profits. While venture capitalists provide approximately $70 billion in capital to companies every year, venture capitalists will typically only invest in a few thousand companies (and such investments are often biased towards highly educated and experienced management teams in limited fields of industry). Angel investors also provide approximately $40 billion in capital to companies every year, though these investments are limited to those companies able to find accredited investors. Unfortunately, less than five percent of the United States population qualifies as an accredited investor, and many of these individuals do not invest in high-risk companies as the individuals are often reaching retirement age and seeking income-generating investments (e.g., real estate).

The JOBS Act allows the general public to access startup companies and other small companies that can take advantage of these new regulations. However, one issue that these regulations do not address is liquidity. Even successful startup companies typically do not provide any liquidity until five to seven years after being founded. Other small companies have longer business cycles where investors have to be very patient. While accredited investors may be accustomed to having capital locked for a long period of time with the hope of a strong return, ordinary investors may not be able to wait this long.

If a company decides to go public, the company will typically hire an investment bank that assists in filing a Form S-1 with the SEC. Once qualified, the company can sell securities to a set of investors during an Initial Public Offering (IPO), and then list the securities on a stock exchange such as the New York Stock Exchange (NYSE) or the Nasdaq Stock Market. Any investor can purchase securities listed on the stock exchange from another investor through a registered broker-dealer. The price of a security can fluctuate based on the supply and demand for the security, and there is an entire industry catered to analyzing/reporting on the securities of these listed companies. These securities were costly to trade until discount brokers (and then online trading websites) became increasingly popular. Today, it costs just a few dollars to execute a trade.

There are approximately half the number of companies listed on stock exchanges today in comparison to 20 years ago. There are several reasons for the decrease. For example, in order to go public, a company generally needs to raise hundreds of millions of dollars to garner interest from the large investment banks. Small businesses have little to no chance to raise this amount of capital. While the JOBS Act allows companies to raise money from the general public, there is no way to provide liquidity to the investors by listing the securities (e.g., shares) on a stock exchange. Even the smaller stock exchanges (e.g., the OTCQX Stock Market) have burdensome requirements, such as a minimum of $5 million in assets and a financial sponsor or an investment bank willing to be a market maker for the company's securities. These represent significant barriers for small companies.

Investors who purchase securities in a company using Regulation Crowdfunding need to wait one year before they can sell those securities to other investors. Regulation A+, meanwhile, does not impose time constraints. However, relatively few companies have listed securities with any kind of stock exchange. An investor has no ability to sell a security unless the investor is able to find another investor who wants to purchase the security. This lack of liquidity is a significant hurdle that will impede ordinary investors, which will in turn cause small companies to struggle in raising capital.

### SUMMARY

Introduced here are computer programs and associated computer-implemented techniques for facilitating complex transactions involving securities through the use of blockchain technology. More specifically, a network-accessible management platform may be responsible for using a blockchain to efficiently and securely manage trades of securities. The network-accessible management platform (also referred to as an “alternative trading system” or “ATS”) can be communicatively coupled to a transfer agent module (also referred to as a “registered transfer agent” or “RTA”) responsible managing the ownership of securities purchased by investors and/or a trading module responsible for receiving input indicative of requested purchases/sales of securities.

The ability to store electronic documents has become the norm in the new digital economy. However, the financial industry has been slow to adopt new technologies that enhance the services provided to investors, reduce the costs to these investors, etc. The ability to store securities in an electronic format in a central database has raised new concerns about the security of the securities and, more importantly, personal information associated with the securities. There have been many well-documented unauthorized accesses (also referred to as “hacks”) of personal information from various government and financial industry databases. Because the information stored in financial industry databases is often very valuable, the consequences of a hack can be very serious. For example, investors may be worried about personal information being stolen and then sold to others, while financial institutions may be worried about reputational harm and the costs of restituting investor losses.

The advent of cryptocurrencies and distributed ledger technologies offer secure, cost-effective solutions for providing security to consumers and lowering costs for the financial industry. An example of a distributed ledger technology is a blockchain. Securities can be securely held using end-to-end encryption, yet openly validated, referenced, and documented so that the securities can be readily authenticated (i.e., trusted as reliable). Investors experience several benefits through the implementation of such technology, including an ability to rely on the authentication, a reduction in costs for maintaining an account, and an ability to readily sell securities whenever they desire.

The network-accessible management platform introduced here can also facilitate transfers of securities categorized under Regulation Crowdfunding, Regulation D, Regulation S, and Regulation A+. In fact, the network-accessible management platform can facilitate transfers of these securities from one investor to another investor without the fear of data loss or the high costs that are ordinarily imposed on securities transfers.

As further described below, the network-accessible management platform may be embodied as a decentralized application that uses blockchain technology. In some embodiments, the network-accessible management platform creates a new cryptocurrency for each company that raises capital in accordance with one of these regulations. Each individual security that is sold can then be represented as a token or a unit of currency (e.g., a coin) in a blockchain. For example, if an investor purchases 100 shares in a company, then those shares can be represented as 100 coins in a distributed ledger on a peer-to-peer network that is maintained by the blockchain. As another example, if a company invests $1,000 in a loan, then the loan can be represented as 1,000 coins in the blockchain. Buyers can use cryptocurrency to purchase securities, and sellers can either keep the cryptocurrency or convert the cryptocurrency into fiat currency.

### BRIEF DESCRIPTION OF THE DRAWINGS

Various features and characteristics of the technology will become more apparent to those skilled in the art from a study of the Detailed Description in conjunction with the drawings. Embodiments of the technology are illustrated by way of example and not limitation in the drawings, in which like references may indicate similar elements.

FIG. 1A illustrates what occurs on the day of the trade (referred to as “T”) in a conventional trading process.

FIG. 1B illustrates what occurs one business day after the day of the trade (referred to as “T+1”) in the conventional trading process.

FIG. 1C illustrates what occurs two business days after the day of the trade (referred to as “T+2”) in the conventional trading process.

FIG. 1D illustrates what occurs three business days after the day of the trade (referred to as “T+3”) in the conventional trading process.

FIG. 2 illustrates a network environment that includes a network-accessible management platform that may be in communication with a trading module and/or a transfer agent module.

FIG. 3 depicts a flow diagram of a process for creating a ticker symbol name for an issuer of securities.

FIG. 4 depicts a data structure that may be created by the management platform during step 305 of FIG. 3.

FIG. 5 depicts a data structure that may be created by the management platform during step 306 of FIG. 3.

FIG. 6 depicts another data structure that may be created by the management platform during step 306 of FIG. 3.

FIG. 7 depicts a data structure that may be created by the management platform in response to determining that a transaction has been agreed to between two investors (e.g., a buyer and a seller).

FIG. 8 depicts a flow diagram of a process for selling securities using a management platform in accordance with some embodiments.

FIG. 9 depicts a flow diagram of a process for buying securities using a management platform in accordance with some embodiments.

FIG. 10 depicts a flow diagram of a process for facilitating a purchase of securities using a management platform.

FIG. 11 is a block diagram illustrating an example of a processing system in which at least some operations described herein can be implemented.

The drawings depict various embodiments for the purpose of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

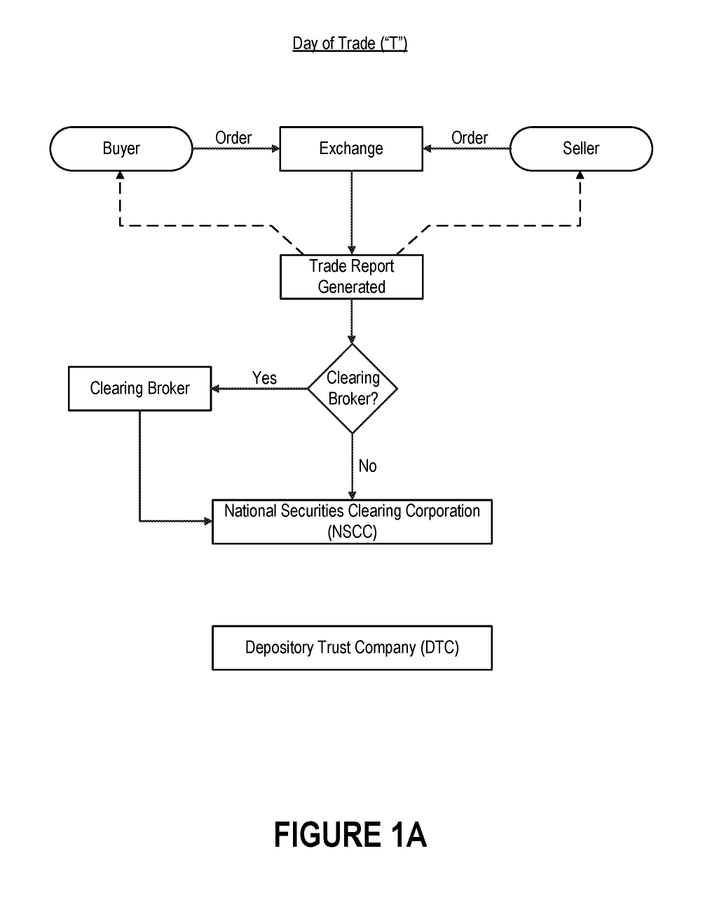

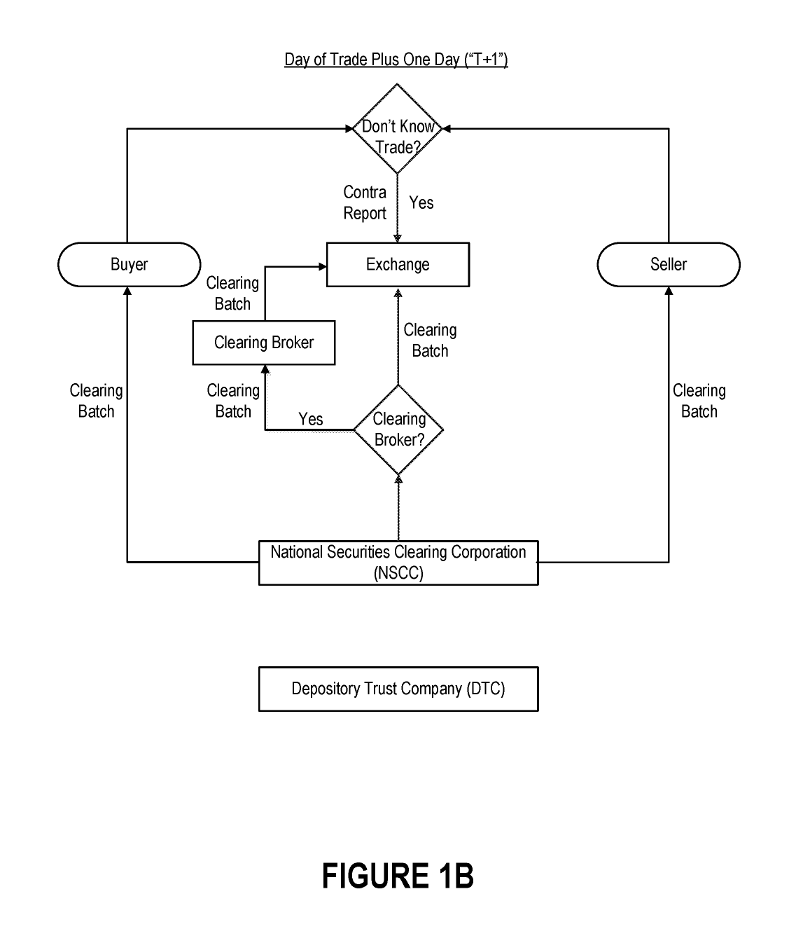

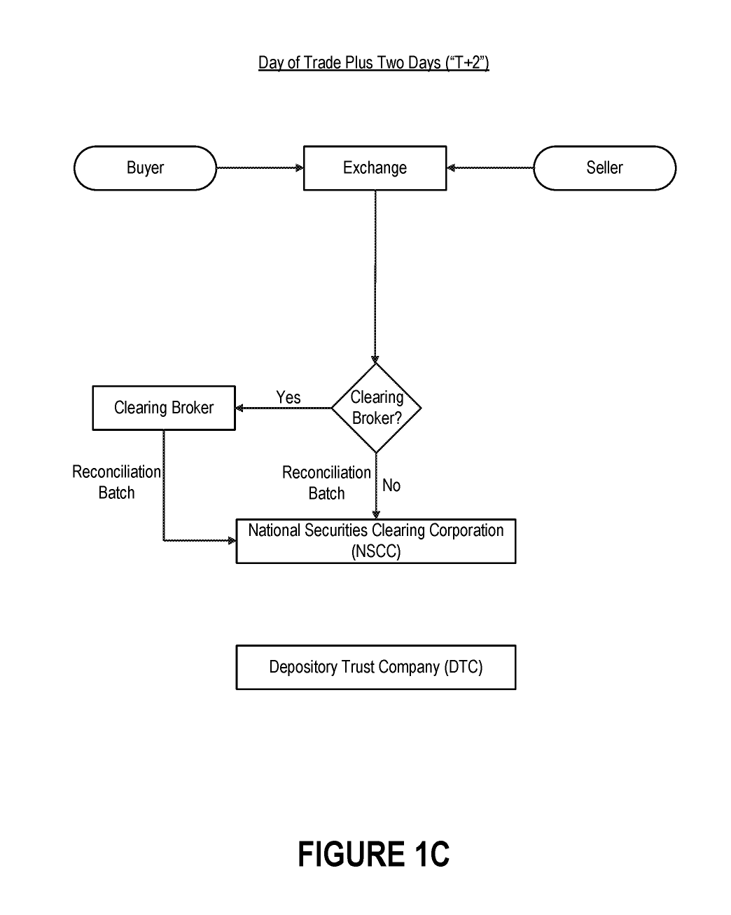

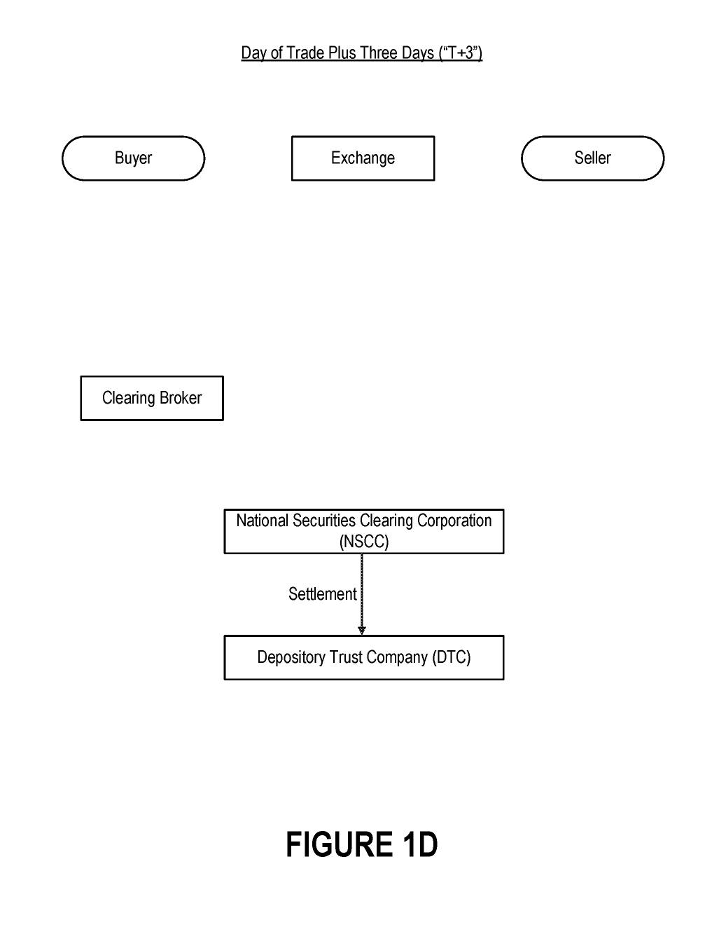

The traditional process for trading securities can take up to three days to complete. FIG. 1A illustrates what occurs on the day of the trade (referred to as “T”). A buyer and seller can initially agree to a transaction involving a security listed on an exchange. For example, a seller may agree to exchange a security (e.g., a stock) in a particular company for cash. The exchange generates a trade report once the terms of the transaction have been agreed to.

The trade report may be sent to a clearing broker that acts as a liaison between the buyer, seller, and a clearing corporation such as the National Securities Clearing Corporation (NSCC). The clearing broker can ensure that the transaction can be settled appropriately. The trade report can then be transmitted by the clearing house to the clearing corporation. In some instances, the trade report is transmitted by the exchange directly to the clearing corporation (i.e., no clearing broker is involved). The clearing corporation provides clearance, settlement, and information services for the security.

FIG. 1B illustrates what occurs one business day after the day of the trade (referred to as “T+1”). Here, clearing batches are sent to the buyer and seller, who have an opportunity to review the transaction. Such action will often cause a significant delay as buyers/sellers are given one business day to dispute the transaction. If the transaction is unfamiliar, the buyer or seller can submit a contra report.

FIG. 1C illustrates what occurs two business days after the day of the trade (referred to as “T+2”). Reconciliation batch(es) are transmitted by the exchange to the clearing corporation. In some instances a reconciliation batch is transmitted directly to the clearing corporation, while in other instances a reconciliation batch is forwarded to the clearing corporation by the clearing broker.

Finally, the clearing corporation can transmit settlement instructions to a security depository such as the Depository Trust Company (DTC). The security depository is responsible for officially changing ownership of the security. Such action is depicted in FIG. 1D, which illustrates what occurs three business days after the day of the trade (referred to as “T+3”).

However, the traditional process for trading securities has several drawbacks. For example, transactions take multiple days to process. This can be particularly problematic for sellers who need cash in short order, which is a problem more often faced by individual investors rather than brokerage firms. As another example, the traditional process simply isn't applicable to some forms of securities (e.g., those categorized under Regulation Crowdfunding, Regulation D, Regulation S, and Regulation A+).

Introduced here, therefore, are computer programs and associated computer-implemented techniques for facilitating complex transactions involving securities through the use of blockchain technology. More specifically, a network-accessible management platform (also referred to as an “alternative trading system” or “ATS”) may be responsible for using a blockchain to efficiently and securely manage trades of securities. The management platform can be communicatively coupled to a transfer agent module (also referred to as a “registered transfer agent” or “RTA”) may be responsible managing the ownership of securities purchased by investors and/or a trading module responsible for receiving input indicative of requested purchases/sales of securities.

The ability to store electronic documents has become the norm in the new digital economy. However, the financial industry has been slow to adopt new technologies that enhance the services provided to investors, reduce the costs to these investors, etc. The ability to store securities in an electronic format in a central database has raised new concerns about the security of the securities and, more importantly, personal information associated with the securities. There have been many well-documented unauthorized accesses (also referred to as “hacks”) of personal information from various government and financial industry databases. Because the information stored in financial industry databases is often very valuable, the consequences of a hack can be very serious. For example, investors may be worried about personal information being stolen and then sold to others, while financial institutions may be worried about reputational harm and the costs of restituting investor losses.

The advent of cryptocurrencies and distributed ledger technologies offer secure, cost-effective solutions for providing security to consumers and lowering costs for the financial industry. An example of a distributed ledger technology is a blockchain. Securities can be securely held using end-to-end encryption, yet openly authenticated, referenced, and documented so that the securities can be readily authenticated (i.e., trusted as reliable). Investors experience several benefits through the implementation of such technology, including an ability to rely on the authentication, a reduction in costs for maintaining an account, and an ability to readily sell securities whenever they desire.

The network-accessible management platform introduced here (which may be embodied as a decentralized application that uses blockchain technology) can also facilitate transfers of securities categorized under Regulation Crowdfunding, Regulation D, and Regulation A+. In fact, the network-accessible management platform can facilitate transfers of these securities from one investor to another investor without the fear of data loss or the high costs that are ordinarily imposed on securities transfers.

In some embodiments, the network-accessible management platform creates a new cryptocurrency for each company that raises capital in accordance with one of these regulations. Each individual security that is sold can then be represented as a token or a unit of currency (e.g., a coin) in a blockchain. For example, if an investor purchases 100 shares in a company, then those shares can be represented as 100 coins in a distributed ledger on a peer-to-peer network that is maintained by the blockchain. As another example, if a company invests $1,000 in a loan, then the loan can be represented as 1,000 coins in the blockchain. Buyers can use cryptocurrency to purchase securities, and sellers can either keep the cryptocurrency or convert the cryptocurrency into actual currency.

The technology described here can reduce the overall cost of buying and selling securities. Moreover, because the blockchain is maintained in a peer-to-peer network, the technology can greatly enhance the security of transactions involving securities. Said another way, security can be enhanced because transaction details can be readily verified by multiple members of the peer-to-peer network. These improvements to efficiency, security, and ease of use can be particularly useful for those investors who do not qualify as accredited investors.

Embodiments may be described with reference to particular cryptocurrencies (e.g., Bitcoin, Ether, or some other fiat money). However, those skilled in the art will recognize that the technology is equally applicable to other cryptocurrencies and token schemes.

The technology can be embodied using special-purpose hardware (e.g., circuitry), programmable circuitry appropriately programmed with software and/or firmware, or a combination of special-purpose hardware and programmable circuitry. Accordingly, embodiments may include a machine-readable medium having instructions that may be used to program an electronic device to perform a process for facilitating the purchase of securities using a token or cryptocurrency, recording transactions using a blockchain, etc.

### Terminology

References in this description to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the words “comprise” and “comprising” are to be construed in an inclusive sense rather than an exclusive or exhaustive sense (i.e., in the sense of “including but not limited to”). The terms “connected,” “coupled,” or any variant thereof is intended to include any connection or coupling between two or more elements, either direct or indirect. The coupling/connection can be physical, logical, or a combination thereof. For example, devices may be electrically or communicatively coupled to one another despite not sharing a physical connection.

The term “module” refers broadly to software components, hardware components, and/or firmware components. Modules are typically functional components that can generate useful data or other output(s) based on specified input(s). A module may be self-contained. A computer program may include one or more modules. Thus, a computer program may include multiple modules responsible for completing different tasks or a single module responsible for completing all tasks.

When used in reference to a list of multiple items, the word “or” is intended to cover all of the following interpretations: any of the items in the list, all of the items in the list, and any combination of items in the list.

### Blockchain Technology Overview

A blockchain is a continuously growing list of records (also referred to as “blocks”) that are linked and secured using cryptography. Each block typically contains a hash pointer as a link to a previous block, a timestamp, and transaction data. Because a blockchain is typically managed by a peer-to-peer network collectively adhering to a protocol for validating new blocks, the blockchain will be inherently resistant to unauthorized modification of the transaction data.

When used as a distributed ledger, a blockchain can serve as the backbone of cryptocurrencies such as Bitcoin and Ether. However, blockchains have a vast number of additional applications. For example, blockchains offer:
Low Cost—No fees are imposed by a middleman. Instead, transfers of cryptocurrencies only require small transaction fees that are paid to the blockchain miners.
Immutability—The distributed ledger is policed by every member in the peer-to-peer network. Accordingly, the integrity of the distributed ledger can be checked and agreed upon by the peer-to-peer network as a whole on an ongoing basis. Any attempted changes to the blockchain can be recognized and rejected by the majority of members.
Transparency—Every action that takes place involving the distributed ledger is visible to all members of the peer-to-peer network. Thus, it is possible to see every action recorded since the beginning of the blockchain.
Irreversibility—Because the distributed ledger is immutable, a transaction that has been recorded into the blockchain cannot be reversed.
Security—Because the blockchain is maintained by a large number of members, an unauthorized entity (also referred to as a “hacker”) cannot gain enough influence to submit a fraudulent transaction. The more valuable the token or cryptocurrency, the larger the peer-to-peer network and, therefore, the more resources it would take for the hacker to conduct fraudulent activities.

One of the first applications of a blockchain was Bitcoin, which was introduced in January 2009 as an innovative and secure currency. Without the blockchain, owners of bitcoin could not guarantee that someone else could not copy the bitcoin and “double spend.” An intermediary (e.g., a bank) normally ensures that such action cannot occur, but this is where costs accrue and delays occur. The intermediary may also prove to be untrustworthy and can reverse a transaction without the permission of either participant. Moreover, the intermediary represents a single point of failure (e.g., the intermediary could be hacked or the transaction could be intercepted by a hacker).

The blockchain technology described above addresses these problems by using a distributed ledger shared amongst members of a peer-to-peer network. While a blockchain makes it difficult to add/modify transactions that are represented as blocks, the blockchain makes it easy for any member of the peer-to-peer network to check if a particular transaction is valid. Thus, fraudulent transactions can be quickly identified and removed from the blockchain.

Smart contracts, meanwhile, are computer protocols intended to facilitate, verify, or enforce the negotiation/performance of a contact. Smart contracts can be represented as code executed on a blockchain. As such, smart contracts can bring significant advantages over existing database-centric applications. For example, decentralized applications (also referred to as “dapps”) can be created for a number of applications that require the security and low costs offered by blockchain technology.

A transfer of cryptocurrency typically does not involve moving the cryptocurrency from one database to another. Instead, the corresponding distributed ledger can be updated to reflect how much cryptocurrency should be owned by each address associated with the participants in the transfer. As further described below, similar techniques can be extended to the trading of securities under certain regulations (e.g., Regulation Crowdfunding, Regulation D, Regulation S, and Regulation A+).

### Technology Overview

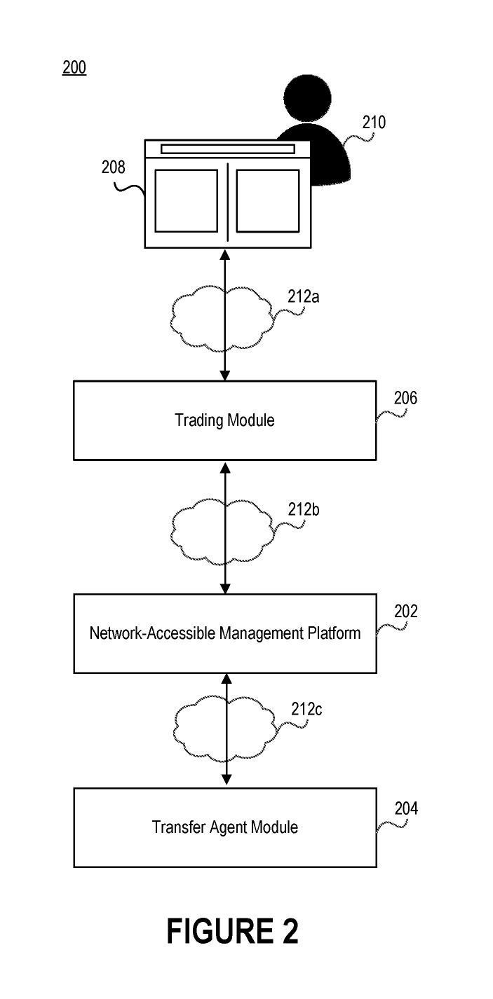

FIG. 2 illustrates a network environment 200 that includes a network-accessible management platform 202 that may be in communication with a transfer agent module 204 and/or a trading module 206. The management platform 202 may be responsible for using a blockchain to efficiently and securely manage trades of securities categorized under Regulation Crowdfunding, Regulation D, or Regulation A+.

The transfer agent module 204 may be responsible for verifying/managing the ownership of these securities that are purchased by investors. Thus, the transfer agent module 204 can become a trusted source for the management platform 202. The trading module 206 may be responsible for receiving input indicative of requested purchases/sales of securities. For example, the trading module 206 may generate an interface 208 through which purchases and sales can be completed.

An investor 210 who has purchased securities can choose to sell the securities using the management platform 202. For example, the investor 206 can post an offer to an interface 208. Similarly, an investor 210 who is interested in purchasing securities can browse securities offered for sale by the trading module 206. The interface 208 is preferably accessible via some combination of a web browser, desktop application, mobile application, or over-the-top (OTT) application. Accordingly, the interface 208 may be viewed on a personal computer, tablet computer, personal digital assistant (PDA), mobile phone, game console (e.g., Sony PlayStation® or Microsoft Xbox®), music player (e.g., Apple iPod Touch®), wearable electronic device (e.g., a watch or fitness band), network-connected (“smart”) device (e.g., a television or home assistant device), virtual/augmented reality system (e.g., a head-mounted display such as Oculus Rift® and Microsoft Hololens®), or some other electronic device. Note, however, that the trading module 206 may be managed by a different entity than the entity responsible for managing the management platform 202 and/or the transfer agent module 204. For example, the entity responsible for managing the trading module 206 may acquire data (e.g., offer terms and relevant transfer restrictions) from the management platform 202 via an application programming interface (API) and/or a bulk data interface.

In some embodiments the terms of the offer are manually specified by the investor 206, while in other embodiments the terms of the offer are automatically determined by the trading platform 206 or the management platform 202 based on one or more pricing models. For example, buyers may enter a buying limit order that sets a ceiling (i.e., a maximum price) on the price of a potential purchase of securities, while sellers may enter a selling limit order that sets a floor (i.e., a minimum price) on the price of a potential sale of securities.

After the offer has been posted, the management platform 202 can verify with the transfer agent module 204 whether the seller owns the securities free and clear, whether there are any transfer restrictions on the securities, etc. For example, the transfer agent module 204 may examine a blockchain corresponding to the issuer of the securities to determine who is the proper owner of the securities.

In some embodiments, the management platform 202 temporarily places a lock (also referred to as a “marker”) on the securities to block any further transactions involving the securities from taking place. Such action may require that the transfer agent module 204 permit at least a portion of the securities be restricted (e.g., not sold by another management platform or broker-dealer for a specified amount of time). Securities locked by a management platform can be unlocked by the same management platform at any time. Securities locked by a management platform can also be automatically released after the expiration of a specified time period (e.g., 5, 7, or 10 days). If an investor attempts to sell a locked security, then the transfer agent module 204 will not accept/approve the transaction until the security is released by the management platform that requested the security be locked.

Another investor can purchase securities offered for sale by the trading module 206 using a token or cryptocurrency (e.g., Bitcoin, Ether, or some other fiat money). For example, some embodiments of the management platform 202 may require that all transactions be completed using Bitcoin. When a cryptocurrency is used to complete a transaction, the management platform 202 facilitates completion of the transaction using a blockchain and a smart contract. Thus, the transaction can be finalized using a peer-to-peer network without intermediaries. After the transaction has been completed, the smart contract can provide the relevant information (e.g., the identity of the buyer and the number of securities purchase) to the transfer agent module 204, which acts as the trusted source for the smart contract. While the identities of the owners of securities may be known to the management platform 202 and/or the transfer agent module 204, such information may not be visible to members of the peer-to-peer network on the blockchain (which can encrypt the information).

Because the management platform 202 enables investors to sell/buy securities using a cryptocurrency, low transaction fees are incurred. However, the transfer agent module 204 may change a small fee to each participant in a transaction. Unlike conventional trading processes, the model introduced here enables investors to make sales/purchases nearly instantaneously in a secure manner. Moreover, the management platform 202 may not impose any fees other than a trading fee and those required to convert cryptocurrency into dollars or some other fiat money.

As noted above, the management platform 202, transfer agent module 204, and trading module 206 may reside in a network environment 200. Thus, the management platform 202, transfer agent module 204, and trading module 206 may be connected to one or more networks 212a-c. The network(s) 206a-b can include local area networks (LANs), wide area networks (WANs), metropolitan area networks (MANs), cellular networks, the Internet, etc.

Some embodiments of the management platform 202 are hosted locally. That is, the management platform 202 may reside on the electronic device used to access the interface 208. For example, the management platform 202 may be embodied as a decentralized application executing on a mobile phone. Other embodiments of the management platform 202 are executed by a cloud computing service operated by Amazon Web Services® (AWS), Google Cloud Platform™ Microsoft Azure®, or a similar technology. In such embodiments, the management platform 202 may reside on a network-accessible computer server. Similarly, the transfer agent module 204 and the trading module 206 can be hosted locally or remotely. For example, the management platform 202, transfer agent module 204, and trading module 206 may all be executed by a cloud computing service, through the management platform 202, transfer agent module 204, and trading module 206 may reside in different containers, virtual private clouds, virtual machines, etc.

A management platform can allow companies (also referred to as “issuers” of securities) to list securities that are to be sold in an offering and listed in a blockchain. These securities may be categorized under Regulation Crowdfunding, Regulation D, Regulation S, or Regulation A+. Initially, the management platform may require that an issuer select a transfer agent module from among multiple transfer agent modules. Each transfer agent module may be associated with a separate registered transfer agent responsible for recording information related to transactions (e.g., the identity of investors and the number of securities transferred). Each transfer agent module must have a contract with at least one management platform and/or trading platform to approve transactions.

Each security offering may be associated with a unique identifier that includes an issuer identifier (which is a unique combination of alphanumeric characters). For example, a security offering identifier may include an issuer identifier comprised of four alphanumeric characters followed by a period and a disbursement number in sequential order. Thus, a first security offering for Company ABCD may be associated with ABCD.1, while a second security offering for the same company may be associated with ABCD.2. Generally, the issuer identifiers (here, ABCD) cannot be modified since they are stored in the blockchain. Because security offering identifiers are stored in the blockchain sequentially, the disbursement numbers must also be unique.

For each investor, the transfer agent module can request that the management platform create a blockchain address that represents owned securities as tokens or units of cryptocurrency. Generally, a transfer agent module designated by an issuer satisfies at least some of the following criteria:
Be associated with a corporation based in the United States;
Be associated with a transfer agent registered with the SEC;
Offer a secure API for interfacing with a computer program associated with a management platform;
Have the ability to lock securities during a transaction;
Have the ability to create unique investor identifiers based on contact information (e.g., email addresses);
Allow recovery of ownership if the contact information is no longer correct using, for example, a sworn affidavit signed by a notary; and
Have agreements with brokers and at least one management platform.

A management platform, meanwhile, typically satisfies at least some of the following criteria:
Be associated with a broker-dealer registered with the SEC;
Be associated with a member of the Financial Industry Regulatory Authority (FINRA);
Have the ability to verify the identity of an investor against one or more databases (e.g., the Anti-Money Laundering (AML) database or Know Your Customer (KYC) database);
Have the ability to verify security ownership with a transfer agent module;
Have the ability to verify any restrictions in a securities agreement signed by an issuer; and
Offer a secure API accessible to a computer program associated with a transfer agent module.

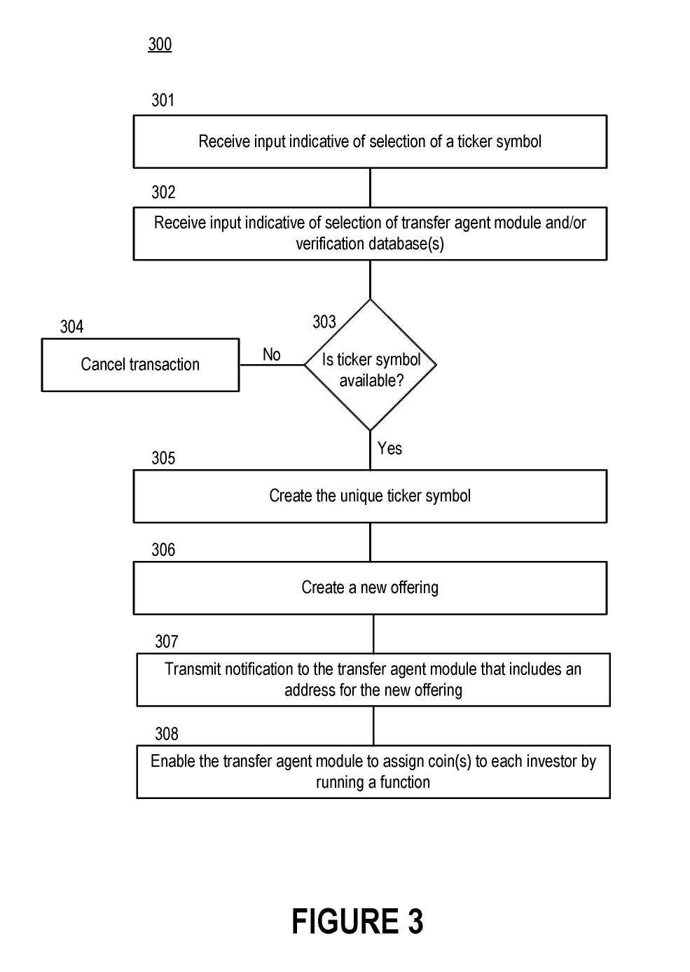

FIG. 3 depicts a flow diagram of a process 300 for creating a ticker symbol name for an issuer of securities. The process 300 may be executed by a management platform embodied as one or more decentralized applications (“dapps”).

Initially, the management platform can receive input indicative of a selection of a ticker symbol (step 301). Generally, the issuer will manually specify a desired ticker symbol through an interface generated by a trading module. However, the management platform could also automatically propose a ticker symbol, and then receive input indicative of a confirmation or denial of the proposed ticker symbol.

The management platform may also receive input indicative of a selection of an transfer agent module and/or one or more verification databases (step 302). As noted above, the transfer agent module may be one of multiple transfer agent modules approved by the issuer. The verification database(s) enable the management platform to verify the identity of investors against one or more databases, such as the AML database, KYC database, etc.

The management platform can then determine whether the ticker symbol is available (step 303). More specifically, the management platform can examine a table of ticker symbols stored in a memory to determine whether any other issuers have already claimed the ticker symbol. If the management platform determines that the ticker symbol is not available, then the management platform can cancel the transaction (step 304). In such a scenario, the management platform may prompt the issuer to select a new ticker symbol.

However, if the management platform determines that the ticker symbol is available, then the management platform can create the ticker symbol (step 305). More specifically, the management platform may create and/or populate a data structure in the memory that dynamically links the ticker symbol to the issuer. For example, if the management platform maintains a table of ticker symbols assigned to issuers, then the management platform can create a new entry in the table that associates the ticker symbol with the issuer.

Thereafter, the management platform can create a new offering for securities offered by the issuer (step 306), and then set the number of tokens or units of cryptocurrency (collectively referred to as “coins”) to zero. The management platform may also automatically transmit a notification to the transfer agent module that includes an address for the new offering (step 307). After receiving the notification, the transfer agent module can assign one or more coins to each investor by running a function (step 308).

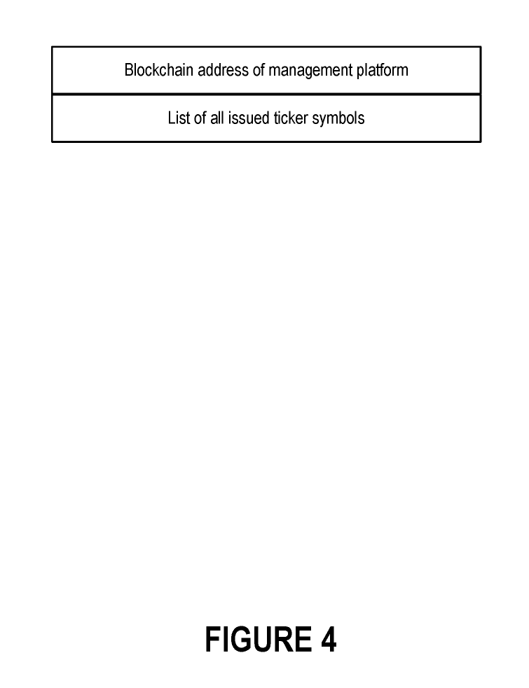

FIG. 4 depicts a data structure that may be created by the management platform during step 305 of FIG. 3. More specifically, the data structure may be created during execution of a specified daap (here, called IssuerName) programmed to create new ticker symbols. Upon creating a new ticker symbol, the management platform may store the new ticker symbol in a data structure that includes a table of all ticker symbols created by the management platform.

Here, for example, the data structure includes the blockchain address of the management platform and a list of all issued ticker symbols. This information may go into the blockchain and remain visible to the public. Pseudocode for creating the data structure is included below in Table I.

TABLE I
Pseudocode for creating a data structure of ticker symbols created by a
management platform.

/*
base contract that sets deployer of contract as owner, initializes a transfer
agent and provides some modifiers and ability to change transfer agent
*/
contract ownedByStartEngine {
address owner;
address issuer;
address transfer_agent; // transfer agent acting as oracle
mapping (string => address) offerings;
function ownedByStartEngine( ) {
owner = msg.sender;
}
event NewOffering(string company_name, string symbol, address
newOffering);
/* Only performable by StartEngine */
modifier onlyOwner {
require(msg.sender == owner);
_;
}
/* Only performable by Transfer Agent */
modifier onlyTransferAgent {
require(msg.sender == transfer_agent);
_;
}
function createOffering(string _company_name, string _symbol, address
_issuer, address
_transfer_agent) onlyOwner {
require(!offerings[_symbol]);
address newOffering = new Offering(_company_name, _symbol,
_issuer, _transfer_agent);
NewOffering(_company_name, _symbol, newOffering);
offerings[_symbol] = newOffering;
}
/* Allows StartEngine to set a new transfer agent */
function updateTransferAgent(address newTransferAgent) onlyOwner {
transfer_agent = newTransferAgent;
}
}

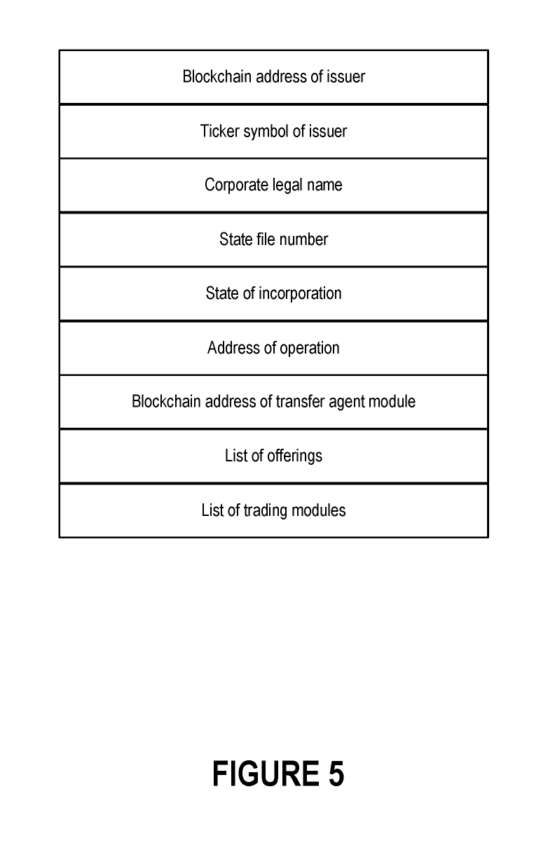

FIG. 5 depicts a data structure that may be created by the management platform during step 306 of FIG. 3. Again, the data structure may be created during execution of a specified daap (here, called IssuerOfferings) programmed to create new offerings. The information included in the data structure may go into the blockchain in such a manner that the information remains visible to the public.

Here, for example, the data structure includes the blockchain address of the issuer, the ticker symbol of the issuer, the corporate legal name, the state file number, the state of incorporation, the address of operation (e.g., physical address, state, and zip code), the blockchain address of a transfer agent module, a list of offerings in sequential order, and a list of trading modules. Embodiments of the data structure may include some or all of these fields.

The management platform may call a function that creates unique cryptocurrency in preparation of the offering. For example, the management platform may call a function named createName( ) that, upon execution, creates the unique cryptocurrency with the opening balance number of securities issued in the offering set to zero. The function may also set the transfer agent module(s) for the management platform using the blockchain address(es) associated with the transfer agent module(s). Pseudocode for the createName( ) function is included below in Table II.

TABLE II
Pseudocode for creating cryptocurrency in preparation of an offering.

/*
Offering that represents a company, has a mapping of addresses (investors)
to an int balance (shares held by address), is a factory to create Trades
*/
contract Offering is ownedByStartEngine {
string public company_name; // name of company that issued shares
string public symbol; // nice asset symbol for display purposes
address[ ] disbursements;
/* Constructor, owner = StartEngine, initial supply is 0 until company
disburses */
function Offering(
string _company_name,
string _symbol,
address _issuer,
address _transfer_agent,
) {
company_name = _company_name;
symbol = _symbol;
issuer = _issuer;
transfer_agent = _transfer_agent;
}
function createDisbursement( ) onlyOwner {
string token_symbol = _symbol + (disbursements.length + 1)
address newDisbursement = new Disbursement(token_symbol,
issuer, transfer_agent);
disbursements.push(newDisbursement);
}
}

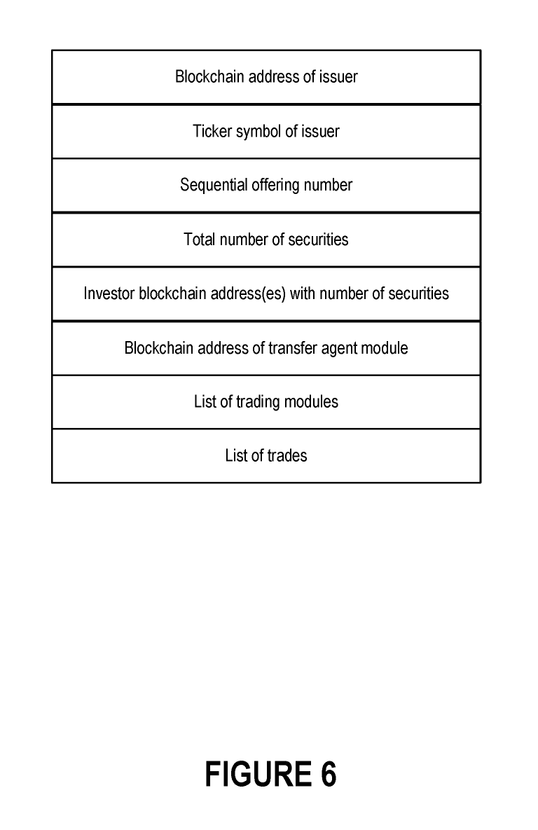

FIG. 6 depicts another data structure that may be created by the management platform during step 306 of FIG. 3. Again, the data structure may be created during execution of a specified daap (here, called Offering) programmed to create new offerings. The information included in the data structure may go into the blockchain in such a manner that the information remains visible to the public.

Here, for example, the data structure includes the blockchain address of the issuer, the ticker symbol of the issuer, the unique sequential offering number, the total number of securities, the list of investor blockchain address(es) with a corresponding number of securities, the blockchain address of a transfer agent module, a list of trading modules, and a list of initiated trades. The list of initiated trades can include all trades, whether completed or not. Embodiments of the data structure may include some or all of these fields.

The transfer agent module can be automatically notified upon the creation of a new offering. Such action allows the transfer agent module to call a function that creates a blockchain address for each investor (also referred to as “shareholders” in the issuer). Moreover, the function may automatically associate each blockchain address with the number of securities owned by the corresponding investor. For example, the transfer agent module may call a function named newShareholder( ) that creates a blockchain address for each investor. Pseudocode for the newShareholder( ) function is included below in Table Ill.

TABLE III
Pseudocode for creating blockchain addresses for investors.

contract Disbursement is ownedByStartEngine {
mapping (address => uint256) balanceOf;
string public token_symbol;
uint256 totalSupply;
address[ ] trades;
function Disbursement(_token_symbol, _issuer, _transfer_agent)
{
token_symbol = _token_symbol;
issuer = _issuer;
transfer_agent = _transfer_agent;
totalSupply = 0;
}
event TradeRequested(address indexed newTrade); // Transfer agent can
listen to TradeRequested events, and approve / cancel event
TradeSettled(address indexed trade); // Event signaling Trade has been
settled, buyer receives shares event TradeCancelled(address indexed
trade); // Event signaling Trade has been cancelled, seller is refunded
shares
/* Adds new shares that have just been issued to investor */
function newShareHolder(address investor, uint256
sharesSold)
onlyTransferAgent {
balanceOf[investor] += sharesSold;
totalSupply += sharesSold;
}
/* Create a new Trade contract, store it in a list, and also send out an event
with the address of
the new contract */
function requestTrade(
address buyer,
uint256 numShares
) public returns(address newTrade) {
address seller = msg.sender;
require(balanceOf[seller] >= numShares); // require the seller to have
enough shares
/* remove shares from seller, “hold” them in a pending Trade and send out
event
*/
balanceOf[seller] −= numShares;
newTrade = new Trade(seller, buyer, numShares, transfer_agent);
trades.push(newTrade);
TradeRequested(newTrade);
return newTrade;
}
/* Send shares balance to buyer address, mark Trade as settled */
function approveTrade(address trade) onlyTransferAgent {
require(trade.pending);
balanceOf[trade.buyer] += trade.numShares;
trade.settle( );
TradeSettled(trade);
}
/* Refund share balance to seller address, mark Trade as cancelled */
function cancelTrade(address trade) onlyTransferAgent {
require(trade.pending);
balanceOf[trade.seller] += trade.numShares;
trade.cancel( );
TradeCancelled(trade);
}
}

Other functions that can be executed by the issuer (e.g., via a trading module) or a transfer agent module include:
updateTransferAgent( )—This function allows the issuer to switch from one transfer agent module to another;
addTradingPlatform( )—This function allows the issuer to add a trading module; and
removeTradingPlatform( )—This function allows the issuer to remove a trading module.

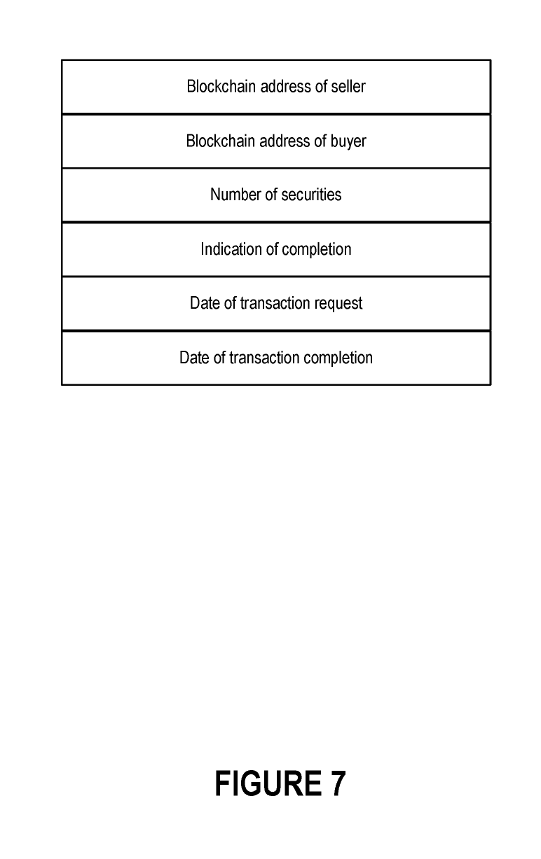

FIG. 7 depicts a data structure that may be created by the management platform in response to determining that a transaction has been agreed to between two investors (e.g., a buyer and a seller). Again, the data structure may be created during execution of a specified daap (here, called SecuritiesTrade) programmed to facilitate the completion of transactions. The information included in the data structure may go into the blockchain in such a manner that the information remains visible to the public.

Here, for example, the data structure include the blockchain address of the seller, the blockchain address of the buyer, the number of securities being transferred, an indication as to whether the transaction has been completed, the date the transaction was requested, and the date the transaction was completed. Embodiments of the data structure may include some or all of these fields.

Upon being notified that a transaction has been finalized, the management platform may call a function that allows an investor (e.g., a seller) to transfer one or more securities to another investor (e.g., a buyer). First, the management platform can check to see if the transaction has been permitted, verify the terms of the purchase agreement, and acquire the blockchain addresses of the seller and buyer. The management platform may acquire the blockchain address of the seller by calling an API associated with a transfer agent module. In such embodiments, the blockchain address of the seller can act as the key for communication between the management platform and the transfer agent module via the API. The management platform may acquire the blockchain address of the buyer by calling an API associated with whichever management platform or trading module discovered or “onboarded” the buyer. In some instances, the same management platform will be responsible for onboarding the buyer and transferring the securities (in which case no external communications are necessary). Then the transfer agent module can approve the transfer. If necessary, the transfer agent module may also create a record/account for any new investor(s) included in the transfer and add the new investor(s) to a list of investors associated with the issuer of the securities.

For example, the management platform may call a function named requestTrade( ) that, upon execution, allows a security to be transferred from one investor to another investor. Pseudocode for the requestTrade( ) function is included below in Table IV.

TABLE IV
Pseudocode for transferring securities between investors.

contract Trade is ownedByStartEngine {
address seller;
address buyer;
uint256 numShares;
bool settled;
bool cancelled;
bool public pending;
function Trade(
address _seller,
address _buy,
uint256 _numShares,
address _transfer_agent,
) {
seller = _seller;
buyer = _buyer;
numShares = _numShares;
transfer_agent = _transfer_agent;
pending = true;
}
modifier onlyPending {
require(pending);
_;
}
function settle( ) public onlyTransferAgent, onlyPending {
pending = false;
settled = true;
}
function cancel( ) public onlyTransferAgent, onlyPending {
pending = false;
cancelled = true;
}
}

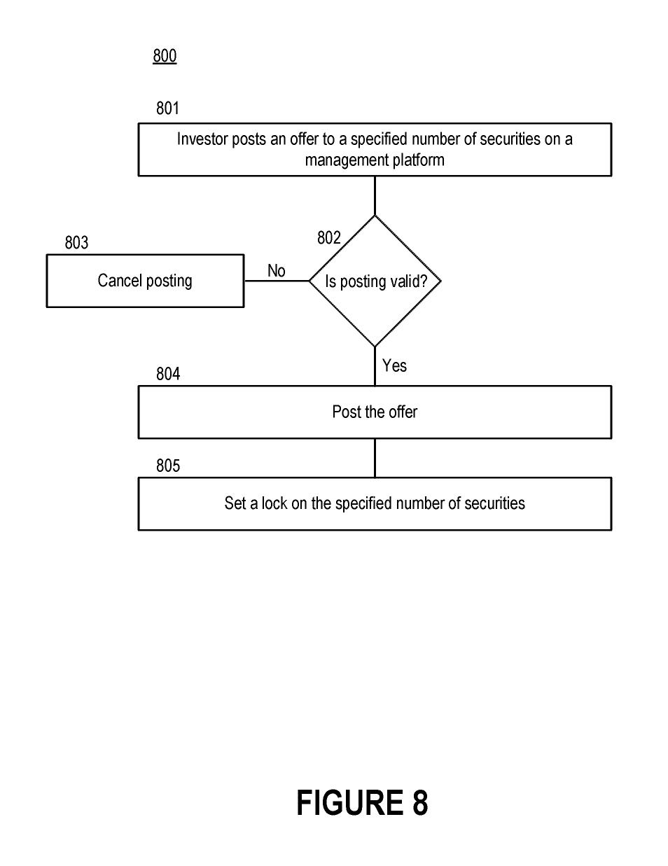

FIG. 8 depicts a flow diagram of a process 800 for selling securities using a management platform in accordance with some embodiments. Initially, an investor can post an offer to sell a specified number of securities on a management platform (step 801). For example, the investor may specify how many securities to sell via an interface (e.g., interface 208 of FIG. 2) generated by a trading module associated with a broker-dealer. The interface is generally accessible on an electronic device.

The management platform can then determine whether the posting is valid (step 802). For example, the management platform may examine information about the investor to see whether the investor has ownership of the securities, is permitted to sell the securities, etc. A transfer agent module communicatively coupled to the management platform may be configured to perform similar actions. If the management platform determines that the posting is not valid, then the management platform can cancel the posting (step 803).

However, if the management platform determines that the posting is valid, then the management platform can post the offer (step 804). Generally, the management platform is designed to post the offer for a specified timeframe (e.g., 7, 10, or 14 days). In response to a determination that the offer has not been accepted within the specified timeframe, the management platform may withdraw the offer or prompt the investor to specify whether the offer should be posted again with the same or different terms.

In some embodiments, the management platform sets a lock on the specified number of securities (step 805). The management platform may set the lock on the specified number of securities before or after the offer is posted. Such action prevents the management platform (or some other management platform) from completing multiple transactions involving the same securities. The management platform can lift the lock in several scenarios. For example, the management platform may lift the lock upon completion of a transfer of the securities, upon expiration of the specified timeframe, etc.

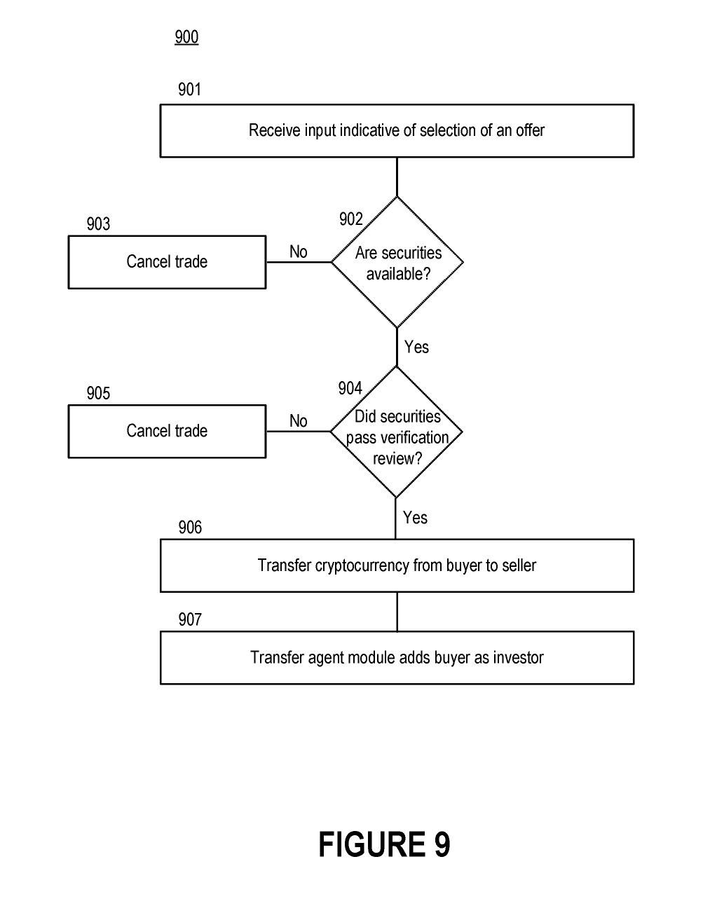

FIG. 9 depicts a flow diagram of a process 900 for buying securities using a management platform in accordance with some embodiments. Initially, a buyer can select an offer to sell a specified number of securities posted on a management platform. More specifically, the management platform may receive input from a trading module indicative of a selection of the offer by the buyer through an interface generated by the trading module (901). Generally, the buyer will browse/select offers via an interface (e.g., interface 208 of FIG. 2) accessible on an electronic device.

The management platform can determine whether the specified number of securities are currently available (step 902). If the management platform determines that the specified number of securities are not currently available, then the management platform can cancel the trade (903). The management platform may examine blocks of the blockchain corresponding to the issuer of the securities to make sure that the securities are valid. Securities may no longer be available because the offer has expired, been accepted by another investor, etc.

However, if the management platform determines that the specified number of securities are currently available, then the management platform can determine whether the securities passed a verification review (step 904). The verification review may require that the management platform verify the securities against an AML database, KYC database, etc. A transfer agent module communicatively coupled to the management platform may be configured to perform a similar action. If the management platform determines that the securities did not pass the verification review, then the management platform can cancel the trade (step 905).

However, if the management platform determines that the securities did pass the verification review, then the management platform can cause an appropriate amount of cryptocurrency to be transferred from the buyer to a seller (step 906). More specifically, the management platform can initiate a transfer of cryptocurrency from a blockchain address associated with the buyer to a blockchain address associated with the seller. The details of the transfer may be recorded in a blockchain for security purposes.

The management platform may also notify a transfer agent module that the transfer has been completed. Thus, in some embodiments, the transfer agent module may add the buyer as an investor in the issuer of the securities (step 907). More specifically, the transfer agent module can add the cryptocurrency address associated with the buyer to a data structure that includes a list of other investors in the issuer.

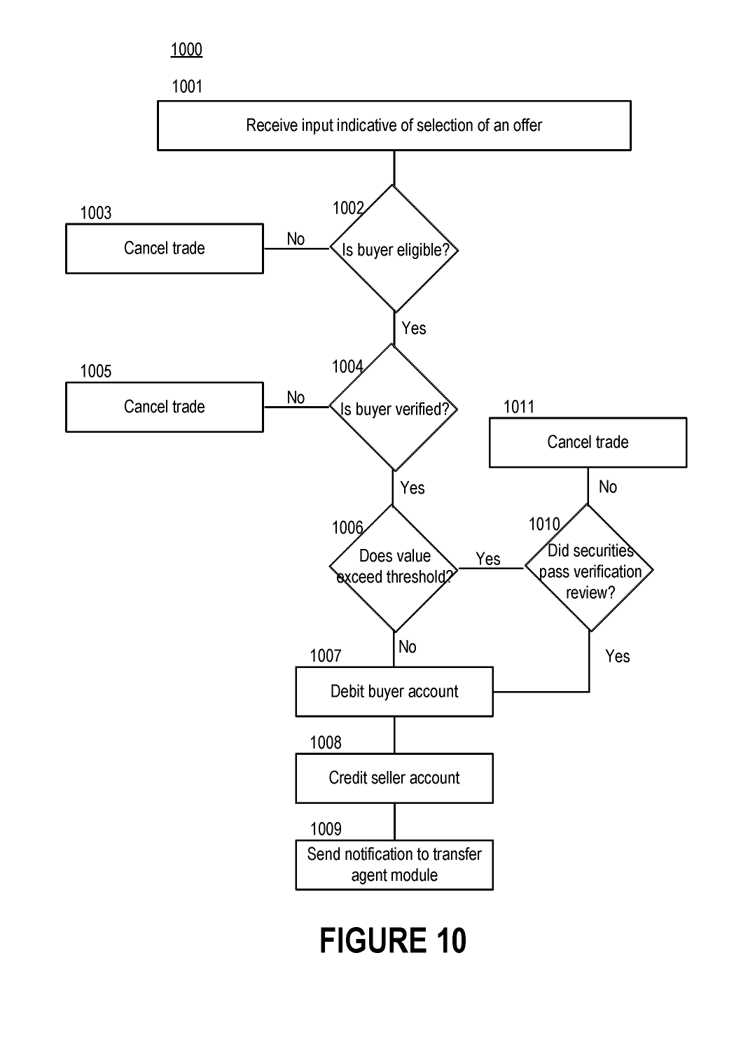

FIG. 10 depicts a flow diagram of a process 1000 for facilitating a purchase of securities using a management platform. Step 1001 of FIG. 10 is substantially similar to step 901 of FIG. 9.

The management platform can determine whether the buyer is eligible to complete the trade (step 1002). For example, the management platform may compare one or more buyer characteristics with characteristic(s) specified in the offer. The buyer characteristic(s) may be stored in a memory accessible to the management platform. Moreover, the buyer characteristic(s) may be linked to the blockchain address associated with the buyer. The management platform may create, host, and/or access accounts corresponding to investors, where each account is linked to the unique blockchain address of the corresponding investor. If the management platform determines that the buyer is not eligible, then the management platform can cancel the trade (step 1003).

However, if the management platform determines that the buyer is eligible, then the management platform can determine whether the buyer has been verified (step 1004). Generally, verification of the buyer is performed by a transfer agent module or a trading module on behalf of the management platform. If the management platform determines that the buyer has not been verified, then the management platform can cancel the trade (step 1005).

However, if the management platform determines that the buyer has been verified, then the management platform can examine the value of the trade (step 1006). The management platform may determine whether the value of the trade exceeds a specified threshold (e.g., $1,000, $2,000, or $5,000). Responsive to a determination that the value of the trade does not exceed the specified threshold, the management platform can facilitate the completion of the trade. More specifically, the management platform can debit a blockchain address or an account associated with the buyer (step 1007), credit a blockchain address or an account associated with the seller (step 1008), and send a notification to the transfer agent module that the trade has been completed (step 1009).

Responsive to a determination that the value of the trade does exceed the specified threshold, the management platform can determine whether the securities passed a verification review (step 1010). Steps 1010 and 1011 of FIG. 10 are substantially similar to steps 904 and 905 of FIG. 9. If the management platform determines that the securities did pass the verification review, then the management platform can proceed to facilitate the completion of the trade (i.e., execute steps 1007, 1008, and/or 1009).

Pseudocode for a function for posting and trading securities is included below in Table V.

TABLE V
Pseudocode for posting and trading securities.

pragma solidity \hat{ }0.4.8;
/*base contract that sets deployer of contract as owner, initializes a transfer
agent and provides some modifiers and ability to change transfer agent
*/
contract ownedByStartEngine {
address owner;
address issuer;
address transfer_agent; // transfer agent acting as oracle
mapping (string => address) offerings;
function ownedByStartEngine( ) {
owner = msg.sender;
}
event NewOffering(string company_name, string symbol, address
newOffering);
/* Only performable by StartEngine */
modifier onlyOwner {
require(msg.sender == owner);
_;
}
/* Only performable by Transfer Agent */
modifier onlyTransferAgent {
require(msg.sender == transfer_agent);
_;
}
function createOffering(string _company_name, string _symbol, address
_issuer, address
_transfer_agent) onlyOwner {
require(!offerings[_symbol]);
address newOffering = new Offering(_company_name, _symbol,
_issuer, _transfer_agent,
NewOffering(_company_name, _symbol, newOffering);
offerings[_symbol] = newOffering;
}
/* Allows StartEngine to set a new transfer agent */
function updateTransferAgent(address newTransferAgent) onlyOwner {
transfer_agent = newTransferAgent;
}
}
/*Offering that represents a company, has a mapping of addresses
(investors) to an int balance (shares held by address), is a factory
to create Trades.*/
contract Offering is ownedByStartEngine {
string public company_name; // name of company that issued shares
string public symbol; // nice asset symbol for display purposes
address[ ] disbursements;
/* Constructor, owner = StartEngine, initial supply is 0 until company
disburses */
function Offering(
string _company_name,
string _symbol,
address _issuer,
address _transfer_agent,
) {
company_name = _company_name;
symbol = _symbol;
issuer = _issuer;
transfer_agent = _transfer_agent;
}
function createDisbursement( ) onlyOwner {
string token_symbol = _symbol + (disbursements.length + 1)
address newDisbursement = new Disbursement(token_symbol,
issuer, transfer_agent);
disbursements.push(newDisbursement);
}
}
contract Disbursement is ownedByStartEngine {
mapping (address => uint256) balanceOf;
string public token_symbol;
uint256 totalSupply;
address[ ] trades;
function Disbursement(_token_symbol, _issuer, _transfer_agent)
{
token_symbol = _token_symbol;
issuer = _issuer;
transfer_agent = _transfer_agent;
totalSupply = 0;
}
event TradeRequested(address indexed newTrade); // Transfer agent can
listen to TradeRequested events, and approve / cancel event
TradeSettled(address indexed trade); // Event signaling Trade has been
settled, buyer receives shares event TradeCancelled(address indexed
trade); // Event signaling Trade has been cancelled,
seller is refunded shares
/* Adds new shares that have just been issued to investor */
function newShareHolder(address investor, uint256
sharesSold)
onlyTransferAgent {
balanceOf[investor] += sharesSold;
totalSupply += sharesSold;
}
/* Create a new Trade contract, store it in a list, and also send out an event
with the address of
the new contract */
function requestTrade(
address buyer,
uint256 numShares
) public returns(address newTrade) {
address seller = msg.sender;
require(balanceOf[seller] >= numShares); // require the seller to have
enough shares
/* remove shares from seller, “hold” them in a pending Trade and send out
event */
balanceOf[seller] −= numShares;
newTrade = new Trade(seller, buyer, numShares, transfer_agent);
trades.push(newTrade);
TradeRequested(newTrade);
return newTrade;
}
/* Send shares balance to buyer address, mark Trade as settled */
function approveTrade(address trade) onlyTransferAgent {
require(trade.pending);
balanceOf[trade.buyer] += trade.numShares;
trade.settle( );
TradeSettled(trade);
}
/* Refund share balance to seller address, mark Trade as cancelled */
function cancelTrade(address trade) onlyTransferAgent {
require(trade.pending);
balanceOf[trade.seller] += trade.numShares;
trade.cancel( );
TradeCancelled(trade);
}
}
/*Represents a Trade Request to be settled by transfer agent, has no real
internal balance but instead is more like a struct that gathers info necessary
to model a real world trade
*/
contract Trade is ownedByStartEngine {
address seller;
address buyer;
uint256 numShares;
bool settled;
bool cancelled;
bool public pending;
function Trade(
address _seller,
address _buy,
uint256 _numShares,
address _transfer_agent,
) {
seller = _seller;
buyer = _buyer;
numShares = _numShares;
transfer_agent = _transfer_agent;
pending = true;
}
modifier onlyPending {
require(pending);
_;
}
function settle( ) public onlyTransferAgent, onlyPending {
pending = false;
settled = true;
}
function cancel( ) public onlyTransferAgent, onlyPending {
pending = false;
cancelled = true;
}
}

Unless contrary to physical possibility, it is envisioned that the steps described above may be performed in various sequences and combinations. For example, a lock may be set on securities before an offer for the securities is posted on a trading module for review by potential buyers. Other steps may also be included in some embodiments.

### Use Cases

A seller, John Doe, has purchased a security categorized under Regulation Crowdfunding, Regulation D, or Regulation A+. John Doe would typically be prevented from transferring the security to another individual. However, John Doe can use the network-accessible management platform introduced here to post an offer to sell the security.

For example, John Doe may pay a one-time posting fee (e.g., $5 or $10) that permits him to display an offer to sell the security for a limited timeframe (e.g., 30, 60, or 90 days) on a trading module. After the limited timeframe expires, John Doe can purchase an opportunity to post another offer. In some instances, another posting fee may be required. For example, the management platform may prompt John Doe to pay another posting fee if any terms of the offer are changed (e.g., the number of securities offered for sale or the price per security).

Once the offer has been posted, the management platform can verify with a transfer agent module that John Doe actually owns the security free and clear. The transfer agent module may also verify whether there are any transfer restrictions on the security. Generally, this requires that the security be locked for a specified amount of time.

A buyer, Jane Doe, can view a listing of posted offers and decide which offer(s) to accept. If Jane Doe wants to purchase the security offered for sale by John Doe, then Jane Doe can interact with an interface accessible on an electronic device. For example, Jane Doe may click a “buy” button presented on a graphical user interface accessible through a computer program. Jane Doe will then pay for the security with a cryptocurrency such as Bitcoin or Ether. Typically, buyers will purchase cryptocurrency from a cryptocurrency wallet company.

To effectuate the transfer, the management platform will transfer the agreed-upon number of cryptocurrency units from Jane Doe to John Doe in exchange for the security. More specifically, the management platform can cause the agreed-upon number of cryptocurrency units to be transferred from a blockchain address associated with Jane Doe to a blockchain address associated with John Doe. This can be accomplished via a peer-to-peer network without intermediaries using a smart contract. Once the transfer is completed, the smart contract can notify the transfer agent module of the identity of the new owner and the number of securities purchased.

As another example, an issuer of securities, Company ABCD, can pay a one-time initiation fee (e.g., $100, $500, or $1,000) that permits Company ABCD to sell securities using a management platform. Generally, Company ABCD will pay the initiation fee in tokens or units of cryptocurrency.

Company ABCD can also provide a blockchain address (also referred to as a “cryptocurrency address”) and an a selection of a transfer agent module to the management platform. Such information may be used by the management platform to create an issuer identifier (here, “ABCD”). The management platform can pay the blockchain miners who host the distributed ledgers of the blockchain corresponding to Company A, and the blockchain address can be used by Company A to charge the transfer agent module.

Thereafter, Company ABCD elects to conduct an offering of 100,000 shares in a Regulation Crowdfunding offering available to 500 investors. Company ABCD can request that the management platform create a new security offering identifier in exchange for an offering fee (e.g., $100, $500, or $1,000). As noted above, the security offering identifier may include the issuer identifier and a disbursement number in sequential order. Thus, the first security offering for Company ABCD may be associated with ABCD.1, while subsequent security offerings for Company ABCD may be associated with ABCD.2, ABCD.3, etc.

The transfer agent module can use the cryptocurrency associated with the offering fee to create a blockchain address for each investor. Each blockchain address can then be programmed to contain the appropriate number of issued securities (which collectively total 100,000 shares). The investors may also use trading module(s) communicatively coupled to the management platform to subsequently trade the shares of Company ABCD amongst each other (and, in some instances, other investors who did not participate in the initial offering).

### Processing System

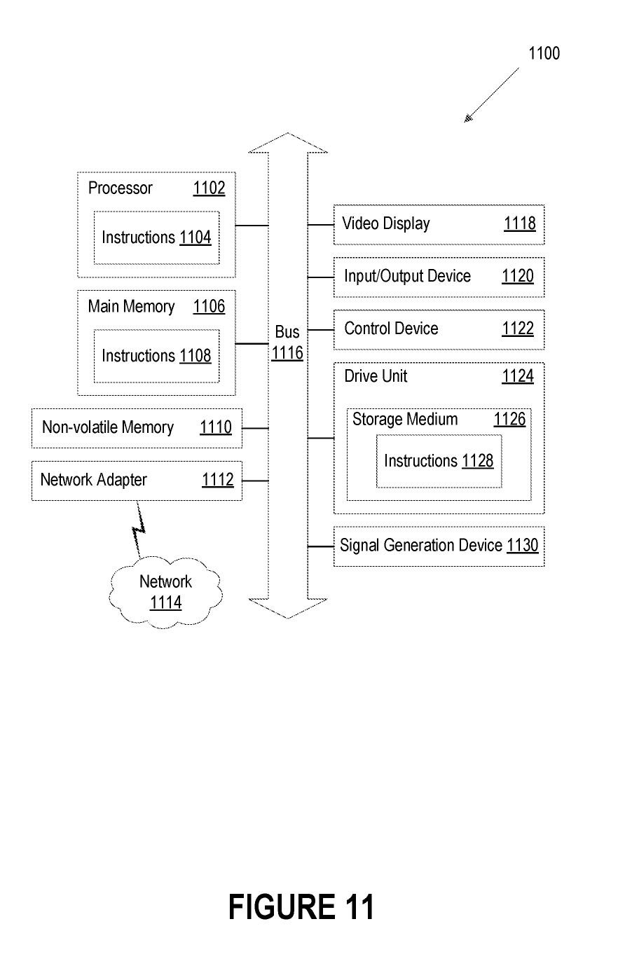

FIG. 11 is a block diagram illustrating an example of a processing system 1100 in which at least some operations described herein can be implemented. For example, some components of the processing system 1100 may be hosted on a computing device that includes a management platform (e.g., management platform 202 of FIG. 2), a transfer agent module (e.g., transfer agent module 204 of FIG. 2), and/or a trading module (e.g., trading module 206 of FIG. 2).

The processing system 1100 may include one or more central processing units (“processors”) 1102, main memory 1106, non-volatile memory 1110, network adapter 1112 (e.g., network interface), video display 1118, input/output devices 1120, control device 1122 (e.g., keyboard and pointing devices), drive unit 1124 including a storage medium 1126, and signal generation device 1130 that are communicatively connected to a bus 1116. The bus 1116 is illustrated as an abstraction that represents one or more physical buses and/or point-to-point connections that are connected by appropriate bridges, adapters, or controllers. The bus 1116, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The processing system 1100 may share a similar computer processor architecture as that of a desktop computer, tablet computer, personal digital assistant (PDA), mobile phone, game console (e.g., Sony PlayStation® or Microsoft Xbox®), music player (e.g., Apple iPod Touch®), wearable electronic device (e.g., a watch or fitness tracker), network-connected (“smart”) device (e.g., a television or home assistant device), virtual/augmented reality systems (e.g., a head-mounted display such as Oculus Rift® or Microsoft Hololens®), or another electronic device capable of executing a set of instructions (sequential or otherwise) that specify action(s) to be taken by the processing system 1100.

While the main memory 1106, non-volatile memory 1110, and storage medium 1126 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1128. The term “machine-readable medium” and “storage medium” shall also be taken to include any medium that is capable of storing, encoding, or carrying a set of instructions for execution by the processing system 1100.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 1104, 1108, 1128) set at various times in various memory and storage devices in a computing device. When read and executed by the one or more processors 1102, the instruction(s) cause the processing system 1100 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1110, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 1112 enables the processing system 1100 to mediate data in a network 1114 with an entity that is external to the processing system 1100 through any communication protocol supported by the processing system 1100 and the external entity. The network adapter 1112 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1112 may include a firewall that governs and/or manages permission to access/proxy data in a computer network, and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

1-7. (canceled)

8. A computer-implemented method for facilitating a purchase of a security on a network-accessible management platform, the method comprising:
receiving, by a management platform, input indicative of a selection of an offer to sell a security in an electronic format,
wherein the selection is made via a graphical user interface accessible on an electronic device;
determining, by the management platform, whether the security is available for inclusion in a transfer;
in response to a determination that the security is available for inclusion in the transfer,
causing, by the management platform, the security to be subject to a verification review;
transferring, by the management platform, a specified amount of cryptocurrency from a blockchain address associated with a buyer of the security to a blockchain address associated with a seller of the security; and
transmitting, by the management platform to a transfer agent module, a notification that specifies the buyer should be added as an investor in an issuer responsible for issuing the security,
wherein receipt of the notification prompts the transfer agent module to add the blockchain address associated with the buyer to a data structure that includes a list of blockchain addresses corresponding to all owners of securities issued by the issuer.

9. The computer-implemented method of claim 8, wherein said determining comprises:
examining, by the management platform, whether a digital lock has been placed on the security by a specified management platform,
wherein the specified management platform is the management platform or some other management platform.

10. (canceled)

11. The computer-implemented method of claim 8, wherein the management platform is communicatively coupled to the transfer agent module across a network.

12. The computer-implemented method of claim 8, said receiving requires the management platform communicate with a trading module configured to generate the graphical user interface via an application programming interface (API).

13. The computer-implemented method of claim 8, wherein the notification is transmitted by the management platform to the transfer agent module via an API.

14. The computer-implemented method of claim 8, further comprising:
determining, by the management platform, that a value of the offer exceeds a specified threshold; and
ensuring, by the management platform, that the security has passed the verification review.

15. A computer-implemented method for facilitating a sale of a security on a network-accessible management platform, the method comprising:
receiving, by a management platform, input indicative of an offer to sell a security in an electronic format that was issued by an issuer;
determining, by the management platform, that the offer is valid;
setting, by the management platform, a digital lock on the security that prevents the management platform or another management platform from including the security in another transaction;
posting, by the management platform, the offer to a graphical user interface for review by one or more potential buyers;
monitoring, by the management platform, whether input indicative of a selection of the offer by a buyer has been received; and
in response to a determination that input indicative of a selection of the offer by the buyer has been received,
transmitting, by the management platform to a transfer agent model, a notification that specifies the buyer should be added as an investor in the issuer.

16. The computer-implemented method of claim 15, wherein said determining comprises:
examining, by the management platform, a blockchain associated with the issuer to confirm that a seller responsible for submitting the offer owns the security.

17. The computer-implemented method of claim 15, further comprising:
receiving, by the management platform, input indicative of a specification of a selling limit that sets a minimum price on a sale of the security.

18. The computer-implemented method of claim 15, further comprising:
releasing, by the management platform, the digital lock on the security following the expiration of a specified timeframe,
wherein said releasing allows the security to be included in another transaction.

19. The computer-implemented method of claim 15, further comprising:
in response to a determination that the input indicative of the selection of the offer has been received,
transferring, by the management platform, a specified amount of cryptocurrency from a blockchain address associated with the buyer to a blockchain address associated with the seller.

20. The computer-implemented method of claim 19, wherein all transfers of securities issued by the issuer are recorded in a distributed ledger maintained by a blockchain, and wherein each owner of at least one security issued by the issuer is a member of a peer-to-peer network responsible for policing the blockchain.

21. A computer-implemented method for facilitating a purchase of a security, the method comprising:
receiving, by a network-accessible management platform, first input indicative of an offer to sell a security by a seller;
causing, by the network-accessible management platform, an electronic representation of the offer to be posted on a graphical user interface for review by one or more potential buyers;
receiving, by the network-accessible management platform, second input indicative of a selection of the electronic representation of the offer by a buyer,
wherein the buyer is one of the one or more potential buyers;
determining, by the network-accessible management platform, that the security is available for inclusion in a transfer from the seller to the buyer;
transferring, by the network-accessible management platform, a specified amount of cryptocurrency from a blockchain address associated with the buyer to a blockchain address associated with the seller; and
transmitting, by the management platform to a transfer agent model, a notification that specifies the buyer should be added as an investor in an issuer responsible for issuing the security.

22. The computer-implemented method of claim 21, further comprising:
causing, by the network-accessible management platform, the security to be subject to a verification review.

23. (canceled)

24. The computer-implemented method of claim 21, wherein receipt of the notification prompts the transfer agent module to add the blockchain address associated with the buyer to a data structure that includes a list of blockchain addresses corresponding to all owners of securities issued by the issuer.
